(19) United States
(12) Patent Application Publication
(10) Pub. No.: US 2010/0030747 A1
(43) Pub. Date: Feb. 4, 2010

(54) DIGITAL PHOTO FRAME CAPABLE OF SEARCHING MEDIA FILES AND METHOD THEREOF

(75) Inventors: MING-FENG TSAI, Tu-Cheng (TW); TE-YUAN KUNG, Tu-Cheng (TW); CHENG-HAO CHOU, Tu-Cheng (TW); XIAO-GUANG LI, Shenzhen City (CN); GUANG-JIN LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/269,047

(22) Filed: Nov. 12, 2008

(30) Foreign Application Priority Data
Aug. 1, 2008 (CN) 200810303306.9

(51) Int. Cl. G06F 7/00; G06F 17/30

(52) U.S. Cl. 707/3; 707/104.1; 707/E17.02; 707/E17.019; 707/E17.044; 707/E17.014

(57) ABSTRACT

A method of searching media file applied on a DPF which includes: a memory, an input unit, a reading module, a determining module; and a displaying module. The method includes: obtaining the search table from the memory via the reading module, wherein the search table records relationships between the duration and a search manner; receiving an operation information of the input unit; determining a search manner according to the duration and the search table via the determining module; searching media files according to the determined search manner via the displaying module.

### FIELD OF THE INVENTION

The disclosure relates to a digital photo frame capable of searching media files and method employed by a digital photo frame to search for media files.

### DESCRIPTION OF RELATED ART

Digital photo frames are designed for displaying digital images without the need to print the digital pictures out and are in people's favors. As advances in microprocessor and other technologies continue to improve the performance of various electronic components, digital photo frames become compactor and more powerful, and are gradually replacing traditional picture frames. Therefore, digital photo frames have become increasingly popular in recent years.

As we known, a digital photo frame may store different types of media files, the media files can be pictures, songs, and so on. When a user wants to search for a desired media file, traditionally, he or she must know some characters of the desired media file, then inputs the characters to search for the desired media file, however, the user often does not remember the characters of media file, additionally, a digital photo frame normally only has some simple input unit, and makes it difficult to input the characters of the desired media file. Of course, the user can search for the desired media file by digital photo frame displaying media files normally, but it will take much time to find the desired media file, and it will waste the user energy, especially, when there is a large number of media files stored in the digital photo frame. Therefore, what is needed is a digital photo frame capable of searching media files quickly and method thereof.

### SUMMARY

A digital photo frame capable of searching media files is provided. The digital photo frame includes a timer, a memory, and a processor. The timer is configured for timing a duration of an input unit being pressed; the memory is configured for storing media files and a search table, wherein the search table records relationships between the duration and a search manner; the processor being connected with the memory, includes a reading module, a determining module, and a displaying module. The reading module configured for obtaining media files and the search table from the memory; the determining module configured for identifying a search manner according to the duration and the search table; and the displaying module is configured for searching the media files according to the identified search manner.

Other advantages and novel features will be drawn from the following detailed description of the preferred embodiment with reference to the attached drawings.

### BRIEF DESCRIPTION OF THE DRAWINGS

The components of the drawings are not necessarily drawn to scale, the emphasis instead being placed upon clearly illustrating the principles of a digital photo frame. Moreover, in the drawings, like reference numerals designate corresponding parts throughout several views.

FIG. 1 is a block diagram of a digital photo frame in accordance with an exemplary embodiment.

FIG. 2 is a flowchart for a method of searching media files in accordance with an exemplary embodiment.

FIG. 3 is an exemplary schematic diagram illustrating a search table with an exemplary embodiment.

FIG. 4 is an exemplary schematic diagram illustrating a state of the screen when selecting a media file in accordance with an exemplary embodiment.

### DETAILED DESCRIPTION OF EMBODIMENTS

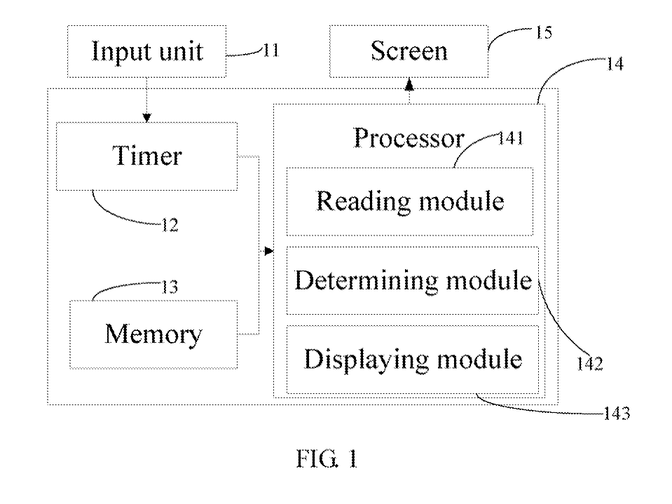

FIG. 1 is an exemplary block diagram of a hardware infrastructure of a digital photo frame in accordance with an exemplary embodiment. The digital photo frame includes at least an input unit 11, a timer 12, a memory 13, a processor 14, and a screen 15.

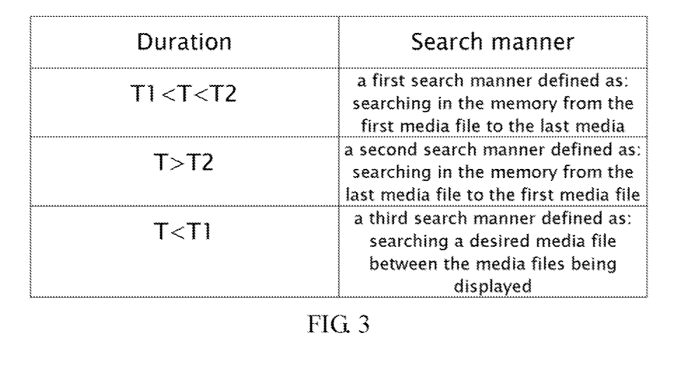

The timer 12 is configured for timing a duration T of the input unit 11 (e.g., a button) being pressed, and sending the duration T to the processor 14. The memory 13 is configured for storing media files and a search table (see FIG. 3). The memory further stores two predetermined times T1 and T2 (T1<T2), wherein T1 and T2 is system default or defined manually (e.g., T1 is 0.05 (s), T2 is 0.1 (s)). The media files include, but not limited to, at least one audio file, at least one image file, or at least one video file. The media files can be sorted according to a predetermined order, such as, creation time, file name, file size, and so on. The search table records relationships between the duration T and a search manner. That is, the search table includes a duration column and a search manner column. The duration column is configured for recording the duration T, and the search manner column is configured for recording the search manner corresponding to the duration T. For example, as shown in FIG. 3, the duration column records three durations: T<T1, T1≦T≦T2, and T>T2, and the search manner column records three corresponding search manners. In the exemplary embodiment, a first search manner corresponding to the duration T1≦T≦T2 is defined as: searching the memory 13 from the first media file to the last media file in the memory 13; a second search manner corresponding to the duration T>T2 is defined as: searching the memory 13 from the last media file to the last media file in the memory 13; and a third search manner corresponding to the duration T<T1 is defined as: searching a desired media file between the media files being displayed on the screen 15.

The processor 14 includes a reading module 141, a determining module 142, and a displaying module 143. The reading module 141 is configured for obtaining media files and the search table from the memory 13. The determining module 142 is configured for searching the search table for the search manner according to the duration T. The displaying module 143 is configured for searching the media files according to the searched search manner. For example, when the determining module 142 determines that the search manner is the first search manner, the displaying module 143 searches desired media files in the memory 13 according to the first search manner periodically. When the determining module 142 determines that the search manner is the second search manner, the displaying module 143 searches desired media file in the memory 13 according to the second search manner periodically. When the determining module 142 determines that the search manner is the third search manner, the displaying module 143 searches desired file according to the third search manner periodically.

In addition, when searching the memory for the media files according to the first or second search manner, the displaying module 143 displays a predetermined count of the searched media files on the screen 15 at every predetermined time period. For example, the displaying module 143 displays four media files on the screen 15 every three seconds. The predetermined time period is less than a time period need for the digital photo frame to display the media files when in a normal state. That means that the digital photo frame can display the media files at a faster speed when searching media files than a speed of displaying the media files in the normal state.

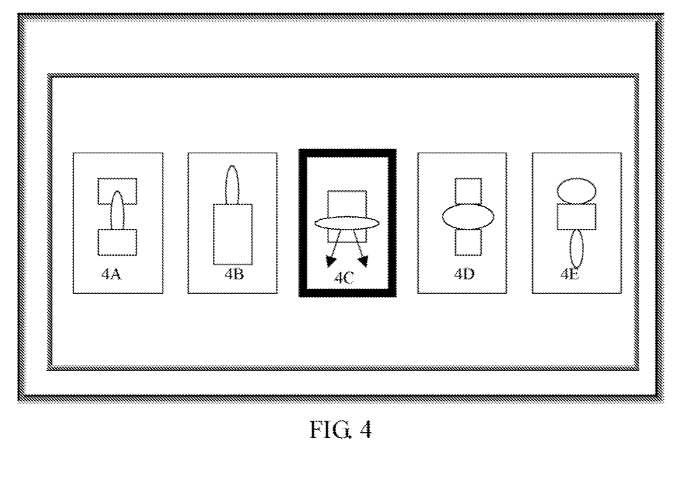

If the input unit 11 is pressed for the duration T<T1 when a desired media file appears on the screen 15 while the displaying module 143 is searching media files in the first search manner or the second search manner, the displaying module 143 switches a current search manner to the third search manner. When the displaying module 143 searches the media files in the third search manner, the displaying module 143 displays one of the media files on display in a thick-edged frame (see FIG. 4). If the input unit 11 is double clicked while the displaying module 143 is searching the media files in the third manner, this means that the media file in the thick-edged frame is the desired media file, the displaying module 143 selects the desired media file and displays the desired media file with full screen.

The digital photo frame further provides a special key for activating the digital photo frame to search the media files in the searching manner. The digital photo frame can also provides a menu item for activating the digital photo frame to search the media files in the searching manner.

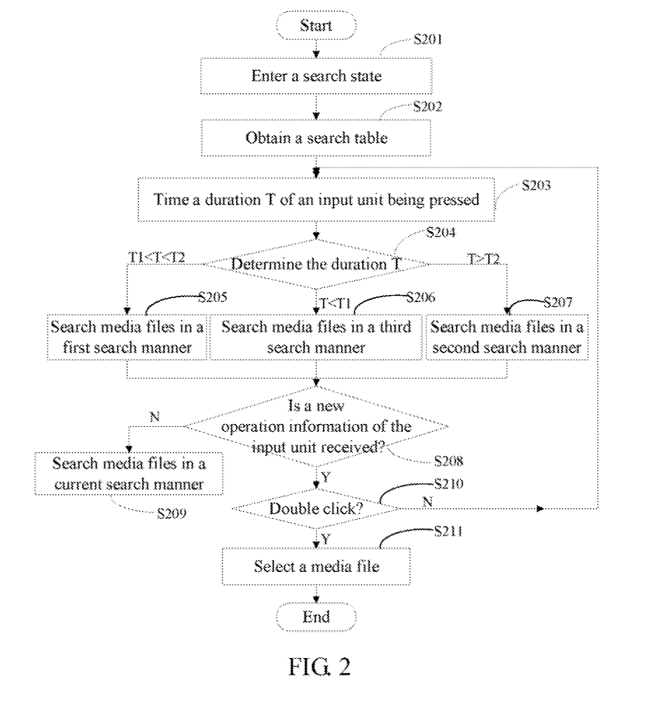

FIG. 2 is a flowchart for a method of searching media files applied in the digital photo frame of FIG. 1 in accordance with an exemplary embodiment.

In step S201, the digital photo frame enters the search state in response to an operation on the special key or the menu item.

In step S202, the reading module 141 obtains the search table from the memory 13.

In step S203, the timer 12 times a duration T of the input unit 11 being pressed.

In step S204, the determining module 142 determines the search manner according to the duration T and the search table obtained from the memory 13.

In step S205, when the duration is T1≦T≦T2, the determining module 142 determines that the search manner is the first search manner, the displaying module 143 searches the desired media files in the first search manner, and the procedure goes to step S208 described below.

In step S206, when the duration is T>T2, the determining module 142 determines that the search manner is the second search manner, the displaying module 143 searches the desired media file in the second search manner, and the procedure goes to step S208 described below.

In step S207, when the duration is T<T1, the determining module 142 determines that the search manner is the third search manner, the displaying module 143 searches the desired media files in the third search manner, and the procedure goes to step S208 described below.

In step S208, the determining module 142 determines whether it receives a new operation information is generated from the input unit 11 in a predetermined time. If the determining module 142 does not receive the new operation information from the input unit 11, the procedure goes to step S209.

If the determining module 142 receives a new operation information from the input unit 11, the determining module 142 further determines whether the operation information is a double click. If the operation information is not the double click, the procedure goes to step S203.

If the operation information is the double click, in step S211, the displaying module 143 selects a desired media file.

In addition, in the search state, when a last media file is searched, the displaying module 143 further displays a prompt to remind the user that the media files in the memory 13 have been searched and whether to search media files again. If not receiving the operation information for searching media files, the digital photo frame switches to the normal state. If receiving the operation information for searching media files, the displaying module 143 searches the media files again.

In the search state, the user can search for a desired media file quickly though the search manner described above. Furthermore, the user can easily switch a search manner to another search manner though the input unit 11. For example, when the displaying module 143 searches media files in the first search manner, namely a current search manner is the first search manner, the user can press the input unit 11 for the duration T which is greater than T2, and thus to switch the current search manner to the second search manner, or press the input unit 11 for the duration T which is less than T1, and thus to switch the current search manner to the third search manner. When the desired media file is searched, the user can select the desired media file by a special operation, for example, pressing the input unit 11 with a double click.

Although the present invention has been specifically described on the basis of the exemplary embodiment thereof, the invention is not to be construed as being limited thereto. Various changes or modifications may be made to the embodiment without departing from the scope and spirit of the invention.

What is claimed is:

1. A digital photo frame (DPF) comprising:
an input unit;
a timer for timing a duration of the input unit being pressed;
a memory for storing media files and a search table, wherein the search table records relationships between durations and search manners; and
a processor being connected with the memory, comprising:
a reading module configured for obtaining media files and the search table from the memory;
a determining module configured for determining a search manner according to the search table and the duration from the timer and; and
a displaying module is configured for searching the media files according to the determined search manner.

2. The DPF as described in claim 1, wherein the determining module is configured to search media files according to the determined search manner until the input unit receives other operation information.

3. The DPF as described in claim 1, wherein the media files in the memory are sorted in a predetermined order.

4. The DPF as described in claim 1, wherein the memory stores two predetermined times T1 and T2, where T1 and T2 is system default or defined manually.

5. The DPF as described in claim 1, wherein when the duration is T1≦T≦T2, where T is a duration of pressing the input unit, the displaying module searches desired media files in a first search manner, which is defined as: searching the memory from the first media file to the last media file;
wherein when the duration is T>T2, the displaying module searches desired media file in a second search manner, which is defined as: searching the memory from the last media file to the last media file; and
wherein when the duration is T<T1, the displaying module searches desired file in a third search manner, which is defined as: searching the desired media file between the media files being displayed.

6. The DPF as described in claim 1, wherein when the displaying module searches the media files in the third search manner, the displaying module displays one of the media files with a thick-edged frame.

7. The DPF as described in claim 1, wherein the displaying module displays the searched media files in a special speed when searching the media files in the first search manner or the second search manner.

8. A method of searching media file applied on a DPF which comprises:
a memory, which stores two predetermined times T1 and T2, where T1 and T2 is system default or defined manually;
an input unit;
a reading module;
a determining module; and
a displaying module,
the method comprising:
obtaining the search table from the memory via the reading module, wherein the search table records relationships between the duration and a search manner;
receiving an operation information of the input unit;
determining a search manner according to the duration and the search table via the determining module; and
searching media files according to the determined search manner via the displaying module.

9. The method as described in claim 8, wherein when the duration is T1≦T≦T2, where T is a duration of pressing the input unit, the displaying module searches desired media files in a first search manner, which is defined as: searching the memory from the first media file to the last media file;
wherein when the duration is T>T2, the displaying module searches desired media file in a second search manner, which is defined as: searching the memory from the last media file to the last media file; and
wherein when the duration is T<T1, the displaying module searches desired file in a third search manner, which is defined as: searching the desired media file between the media files being displayed.

10. The method as described in claim 8, further comprising: when searching to the last media file, displaying a prompt to remind the user that there is no desired media file and whether to searching again.

11. The method as described in claim 10, further comprising: after displaying the prompt, if no new operation information is received, searching media files in the determined search manner; and if new operation information is received, determining a new search manner and searching media file in the new search manner.
